(19) United States
(12) Patent Application Publication
(10) Pub. No.: US 2020/0043447 A1
(43) Pub. Date: Feb. 6, 2020

(54) SMART INSTRUMENT

(71) Applicant: THE JOHNS HOPKINS UNIVERSITY, Baltimore, MD (US)

(72) Inventor: Serap Bastepe-Gray, Hunt Valley, MD (US)

(21) Appl. No.: 16/499,651

(22) PCT Filed: Mar. 27, 2018
(86) PCT No.: PCT/US2018/024489

§ 371 Date: Sep. 30, 2019

Related U.S. Application Data
(60) Provisional application No. 62/478,795, filed on Mar. 30, 2017.

(51) Int. Cl. G10D 3/06; G01L 5/06

(52) U.S. Cl. CPC G10D 3/06; G01L 5/06

(57) ABSTRACT

The present invention is directed to a device and method for measuring forces applied to actuating elements of a musical instrument. The present invention does not alter the feel and operation of the actuating elements of the musical instrument. Therefore, authentic performances can be executed with the device of the present invention, while allowing for collection of time-dependent force data and display of this data in real-time with a graphic interface. The present invention can be used in occupational biomechanics and research on upper extremity biomechanical exposure for musicians. The information produced by a device and method according to the present invention can be used for training musicians in technique. The present invention can also be used for ergonomic assessment of instruments, playing position, playing environments, and other factors impacting playing a musical instrument.

### CROSS REFERENCE TO RELATED APPLICATIONS

This application claims the benefit of U.S. Provisional Patent Application No. 62/478,795, filed on Mar. 30, 2017, which is incorporated by reference herein, in its entirety.

### FIELD OF THE INVENTION

The present invention relates generally to musical instruments. More particularly, the present invention relates to a device and method for measuring forces applied to actuating elements of a musical instrument.

### BACKGROUND OF THE INVENTION

Musicians experience a disproportionate incidence of playing-related musculoskeletal and neurological disorders (PRMD) with reported prevalence rates of 39-89% in working musicians and 11-64% in student-musicians in training in higher education settings. Further, active music making is not only a job, but also a meaningful occupation to about 62 million amateur instrumentalists in the U.S. According to inferences from a pilot study, more than 6 million Americans play a musical instrument for 20 or more hours per week as a serious leisure activity, and 19.7 million of America's amateur instrumentalists experience significant pain in their arms, hands and necks. Epidemiological studies report PRMD in 17%-38% in high school musicians and 67% in children. Despite heightened awareness in the last 30 years in musicians' occupational health, high PRMD rates prevail, and around 12% of professionally trained musicians permanently discontinue their vocation due to injuries.

Playing musical instruments involve complex neuro-mechanical interactions between biomechanical structures and neural processes. Unlike the neural and cognitive processes, little is known about the biomechanical mechanisms despite the obvious critical importance in musicians' health as well as music pedagogy for injury prevention and rehabilitation. This critical knowledge gap is largely confined by the absence of sophisticated technical experimental devices that can allow recording of biomechanically relevant variables in 3-dimentional (3-D) space including a lack of tools that can assess operating forces applied to the sound producing mechanisms of musical instruments, notably the stringed instruments.

Research that aims to improve instrumental pedagogy resulted in an emerging knowledge base of expert movement through biomechanical examination of hands and upper extremity. However, the majority of these studies involve piano playing. A small number of studies are conducted on bowed-string instruments, yet the majority of these focus on the large movements of the bowing arm, and the investigations on the left distal upper extremity are largely confined to surface electromyography studies. Only a few small-scale studies investigate the relationship between pain, PRMD and biomechanical attributes of upper extremity and hand during performance. Touch-sensing technology has been employed to the guitar neck with pressure-pads to determine the “notes” that are being played in an effort to facilitate application of midi-technology and gaming, however, these instruments eliminate the strings and are unable to record time-dependent forces applied to the neck with fingers, thus rendering them useless in biomechanical applications.

Measuring force in stringed instruments has technical challenges due to issues with the structural integrity and the tension applied to the neck and body of these instruments by the strings. Despite documented high rates of upper extremity musculoskeletal disorders in stringed instrument players, and the established importance of task related force measurement in the ergonomic assessment and intervention protocols for upper extremity, such an application has not been reported in the literature.

Accordingly, there is a need in the art for a device and method for measuring force on actuating elements of musical instruments.

### SUMMARY OF THE INVENTION

The foregoing needs are met, to a great extent, by the present invention which provides a device for measuring force used in playing a musical instrument. The device includes an actuating element, wherein the actuating element must be engaged either directly or indirectly by a musician in order to create a sound with the musical instrument. The device also includes a force transducer coupled to the actuating element, such that a force applied to the actuating element is detected by the force transducer.

In accordance with an aspect of the present invention, a non-transitory computer readable medium is programmed for measuring and analyzing forces detected by the force transducers. A display is included to show the musician the forces detected by the force transducers. The musical instrument is one selected from a group of guitar, violin, cello, bass, bass guitar, and viola. The actuating element is one selected from a group of at least one of a nut, a bridge, a fret, a fretboard, and a fingerboard. The actuating element includes a fret wire. The fret wire extends across a latitudinal axis of the actuating element. A display is included to show the forces applied. A source of feedback to the user when the force applied is outside of a predetermined range can also be included.

In accordance with another aspect of the present invention, a method of measuring force used in playing a musical instrument includes detecting force applied to an actuating element of the musical instrument. The actuating element is engaged either directly or indirectly by a musician in order to create a sound with the musical instrument. The method includes measuring the force applied to the actuating element and analyzing the forces applied to the actuating element. The method also includes displaying the forces applied to the actuating element.

In accordance with another aspect of the present invention, the method includes providing feedback to the user if the force applied is outside of a predetermined range. The feedback takes the form of haptic feedback. The method includes detecting the force applied to a string of a stringed instrument. The method further includes detecting the force applied to a fret wire of a guitar.

In accordance with yet another aspect of the present invention, a device for measuring force used in playing a stringed musical instrument includes a base. The device includes a finger contact board including a fret support beam on an under side of the finger contact board. The fret support beam is positioned between the finger contact board and the base. A cantilever sensor is positioned between the base and the finger contact board, wherein the cantilever sensor transmits force information to a processor for analysis of forces applied.

In accordance with still another aspect of the present invention, the cantilever sensor further includes a strain gauge. The strain gauge can take the form of a pair of strain gauges connected by a Wheatstone bridge. A fret wire is positioned across a latitudinal axis of the finger contact board. The musical instrument is one selected from a group of guitar, violin, cello, bass, bass guitar, and viola. The device includes a non-transitory computer readable medium programmed for measuring and analyzing forces detected by the force transducers.

### BRIEF DESCRIPTION OF THE DRAWINGS

The accompanying drawings provide visual representations, which will be used to more fully describe the representative embodiments disclosed herein and can be used by those skilled in the art to better understand them and their inherent advantages. In these drawings, like reference numerals identify corresponding elements and:

FIGS. 1A-1E illustrate a force sensing guitar and an associated display according to an embodiment of the present invention.

FIG. 2A illustrates a fret-based cantilever sensor assembly, according to an embodiment of the present invention. FIG. 2B illustrates the fret-based cantilever sensor assembly of FIG. 2A coupled to a neck of a stringed instrument, according to an embodiment of the present invention.

FIGS. 3A and 3B illustrate graphical views of force measurement characteristics of the present invention.

FIG. 4 illustrates graphical views of finger force output by a novice and an expert guitarist during two non-standardized tasks.

### DETAILED DESCRIPTION

The presently disclosed subject matter now will be described more fully hereinafter with reference to the accompanying Drawings, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

The present invention is directed to a device and method for measuring forces applied to actuating elements of a musical instrument. The present invention does not alter the feel and operation of the actuating elements of the musical instrument. Therefore, authentic performances can be executed with the device of the present invention, while allowing for measurement and collection of time-dependent force data and display of this data in real-time with a graphic interface. The present invention can be used in occupational biomechanics and research on upper extremity biomechanical exposure for musicians. The information produced by a device and method according to the present invention can be used for training musicians in technique. The present invention can also be used for ergonomic assessment of instruments, playing position, playing environments, and other factors impacting playing a musical instrument.

The present invention can be implemented in a number of musical instruments where force is applied to an actuating element, such as a string, a key, or a valve. In particular, the present invention can be implemented in stringed instruments, where a string is pressed to a fretboard or a fingerboard. In a stringed instrument pressure is applied by the musician to the string, fret (if present), and fretboard or fingerboard of the instrument. Such stringed instruments can include, but are not limited to a guitar, violin, viola, cello, bass, bass guitar, or banjo. This pressure applied to these elements can then be measured and recorded using a device according to the present invention. In some implementations of the present invention, time-dependent 3D force data can be recorded and displayed in real-time with a graphic interface on a dedicated screen associated with the present invention, or on the screen of a user's device. The display device can be a personal computer, networked terminal, tablet, phablet, smartphone, or other device known to or conceivable to one of skill in the art. A guitar with pressure sensors is described in detail herein, as an exemplary embodiment of the present invention. The guitar example is not meant to be considered limiting and, it should be noted that the present invention can be implemented on a number of musical instruments.

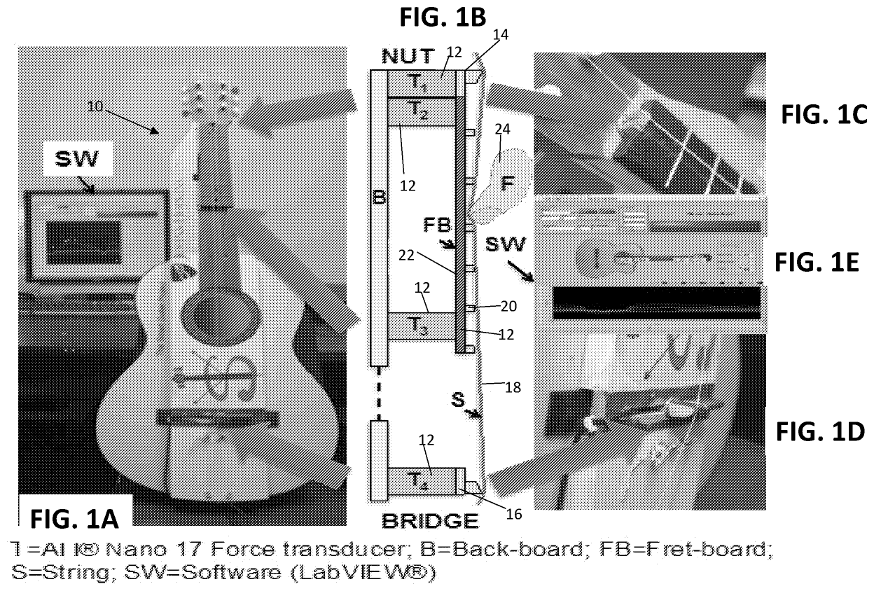

FIGS. 1A-1E illustrate a force sensing guitar and an associated display according to an embodiment of the present invention. The guitar 10 illustrated in FIGS. 1A-1D includes several force transducers 12. Force transducers 12 are placed under the nut 14 and the bridge 16 to measure the finger forces necessary to bend the strings 18 down to contact the frets 20 of the guitar 10. Additional force transducers 12 are placed under a flap of the fretboard 22. Multiple force transducers 12 can be placed under the flap of the fretboard 22 in order to capture force applied onto the fretboard 22 and in different positions on the fretboard. FIG. 1B illustrates a schematic diagram of force transducer 12 placement under the nut 14, bridge 16, and fretboard 22. As illustrated in FIG. 1B, pressure is applied to the string 18 by a finger of the musician 24. FIG. 1C illustrates placement of a force transducer 12 under the nut 14, in greater detail, and FIG. 1D illustrates placement of a force transducer 12 under the bridge 16, in greater detail.

FIG. 1E illustrates an image view of a graphical user interface showing the force applied to the various transducers. In some instances, the user interface can include information on the force being applied to the force transducers, such as whether it is too great, improperly applied, or any other factor known to or conceivable to one of skill in the art. The graphical user interface illustrated in FIG. 1E is associated with software of the present invention that measures, processes, and displays the force information. The software of the present invention can be fixed on a non-transitory computer readable medium. The software can be directly on the computing device of the musician or other user of the force sensing instrument. Alternately, the software can be accessed on a networked computer, over the internet, via a server, or any other configuration known to or conceivable to one of skill in the art.

According to an embodiment of the present invention, force sensing technology and identified transducers include appropriate parameters, such as short response time, excellent linearity and repeatability, high resolution and dimensions small enough to fit the guitar neck without altering the instrument's shape. In one embodiment of the present invention, four ATI Nano 17 transducers are placed in a classical guitar. Two of these transducers are placed under the bridge and under the nut to measure finger forces necessary to bend down the strings until contact with the frets. The remaining two transducers are embedded under a flap of fretboard (includes first 6 frets) on each side to measure the finger forces applied onto the fretboard following the contact of the string to the frets, as illustrated in FIGS. 1A-1D.

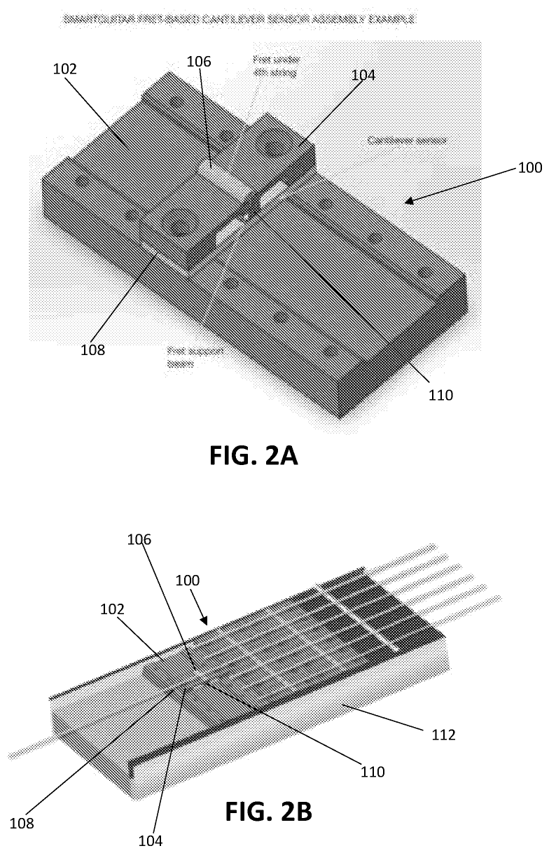

FIG. 2A illustrates a fret-based cantilever sensor assembly, according to an embodiment of the present invention. FIG. 2B illustrates the fret-based cantilever sensor assembly of FIG. 2A coupled to a neck of a stringed instrument, according to an embodiment of the present invention. As illustrated in FIG. 2A, a sensor assembly 100, includes a base 102 and a finger contact board 104. The fret wire 106 is positioned in the middle of the finger contact board 104. A cantilever sensor 108 is positioned between the base 102 and the finger contact board 104. A fret support beam 110 is positioned beneath the fret 106 and in contact with the cantilever sensor 108. Preferably, the cantilever sensor 108 will take the form of a strain gauge. When force is applied to the fret-wire 106, the fret support beam 110 presses down into the cantilever sensor 108. The force compresses the top of the fret support beam 110 and stretches the bottom of the fret support beam. Strain gauges are positioned at a top and a bottom of the cantilever sensor 108. These strain gauges are connected to form a Wheatstone bridge. FIG. 2B illustrates the fret-based cantilever sensor assembly 100, described with respect to FIG. 2A, above, coupled to the neck 112 of the guitar. In a preferred embodiment of the present invention, a fret-based sensor assembly, as illustrated in FIG. 2B will be embedded under every fret of the guitar.

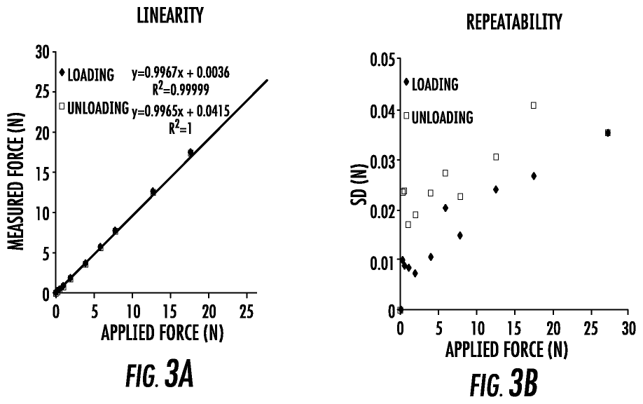

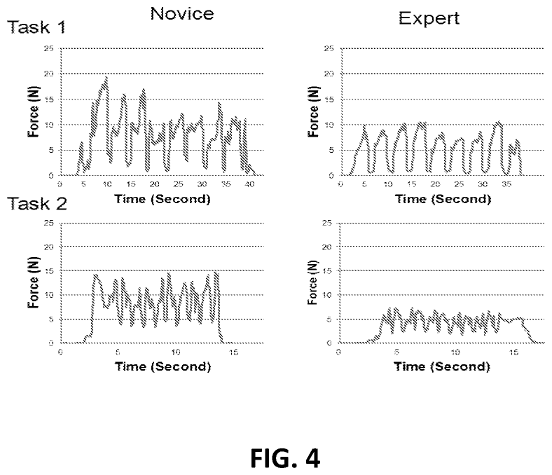

Software code associated with an exemplary implementation of the present invention includes computation and display of the total force output of the fingers over time during performing standardized tasks on the guitar. Loading and unloading tests with deadweights showed that the exemplary embodiment of the present invention, implemented in a guitar, has excellent linearity (R=0.9999), almost no hysteresis and excellent repeatability with average standard deviation of 0.02N over 10 trials, as illustrated in FIGS. 3A and 3B. FIGS. 3A and 3B illustrate graphical views of force measurement characteristics of the present invention. FIG. 3A illustrates linearity of the force measurements, and FIG. 3B illustrates repeatability of the force measurements. In an exemplary implementation of the present invention, finger forces applied by an expert and a novice player on G and D strings during the performance of two standardized tasks were recorded. The novice player showed higher peak forces and force-production rates and more variability between the iterations of the tasks, as illustrated in FIG. 4. FIG. 4 illustrates graphical views of finger force output by a novice and an expert guitarist during two non-standardized tasks.

In another embodiment of the present invention, the fretboard flap can be increased to include the first 12 frets. Four 3-D force sensors can be embedded under the four corners of this flap, essentially creating a mini force-plate. A plate formed from carbon-fiber, aluminum, or any other suitable material known to or conceivable to one of skill in the art can be used for backing the fret-board flap the back of the neck to increase stiffness. Bars, preferably formed from a material such as carbon fiber, can be added to the neck to increase its strength and to provide the neck integrity. Two additional force sensors can also be included, one under the bridge, and another under the nut to continue to capture the finger forces necessary for bending the strings.

The first two embodiments described herein capture cumulative forces applied to the strings and the fretboard applied by one or more fingers. In another embodiment of the present invention, in order to estimate forces applied by each finger individually, a force sensing linear potentiometer (FSLP) is placed under each fret. FSLP allows for collection of both force and location data. Each fret is articulated into 6 pieces, such that each piece under the corresponding string can transfer the force applied by the finger to a known location on the FSLP that corresponds to the particular fret/string intersections immediately behind and in front of the force application point. The signal amplifier and the A/D board are incorporated into the guitar to preserve the authentic feel of the instrument. Additionally, two additional force sensors are included one under the bridge, and another under the nut to continue to capture the finger forces necessary for bending the strings.

In another embodiment of the present invention, individual force sensors such as force sensing resistors are placed under each articulated fret piece. This configuration enables simultaneous detection of multiple contact points on each fret.

In another embodiment, the articulated fret pieces are mounted on thin strips which are mounted on the neck of the instrument such that the fret is at the end of a cantilever formed by the strip. A force sensor capable of detecting small deflections such as a strain gauge, load cell, optical sensor, etc. is either mounted on the underside of the cantilever strip, or integrated into it such that when the instrument string contacts the fret, the cantilever strip slightly bends, resulting in a detectable signal change from the sensor.

In another embodiment, a sensor is integrated into the space between the frets to detect the amount of deflection of the string, which can be related back to the force through calibration. This could be a sensor detecting deflection such as an optical sensor or depressible button which detects the distance that the string has deflected, or a force or pressure sensor which the string is pressed into that detects the force with which the string is pressed into the space between the frets.

In all of these embodiments, the data detected by the sensors in the device can be used to provide feedback to the user in a variety of ways. One way is to provide the user with a retrospective analysis of sensor data coordinated with their musical score and audio recordings of their performance. Another way is to provide real time feedback about the sensor data while the user is playing, which could be done using visual feedback such a screen or lights such as LEDs mounted on the instrument, audio feedback such as a by modulating the guitar sound or adding an additional sound with properties (volume, frequency, etc.) calculated from the sensor readings, or haptic feedback using actuators such as vibration motors, which can be fixed to the user's body or to the instrument.

All of the exemplary embodiments described herein include software with graphic interface to collect and display time-dependent force data on digital screen via plug-in codes included in the software. Parts of the present invention can be carried out using a computer, non-transitory computer readable medium, or alternately a computing device or non-transitory computer readable medium incorporated into the musical instrument device, associated with the present invention. Indeed, any suitable method of calculation known to or conceivable by one of skill in the art could be used. The musical instrument can be connected to the computing device using wired or wireless connections known to or conceivable to one of skill in the art, including WiFi and Bluetooth®.

A non-transitory computer readable medium is understood to mean any article of manufacture that can be read by a computer. Such non-transitory computer readable media includes, but is not limited to, magnetic media, such as a floppy disk, flexible disk, hard disk, reel-to-reel tape, cartridge tape, cassette tape or cards, optical media such as CD-ROM, writable compact disc, magneto-optical media in disc, tape or card form, and paper media, such as punched cards and paper tape. The computing device can be a special computer designed specifically for this purpose. The computing device can be unique to the present invention and designed specifically to carry out the method of the present invention.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention. While exemplary embodiments are provided herein, these examples are not meant to be considered limiting. The examples are provided merely as a way to illustrate the present invention. Any suitable implementation of the present invention known to or conceivable by one of skill in the art could also be used.

1. A device for measuring force used in playing a stringed musical instrument comprising:
a base;
a finger contact board comprising a fret support beam on an under side of the finger contact board, such that the fret support beam is positioned between the finger contact board and the base;
a cantilever sensor positioned between the base and the finger contact board, wherein the cantilever sensor transmits force information to a processor for analysis of forces applied.

2. The device of claim 1 wherein the cantilever sensor further comprises a strain gauge.

3. The device of claim 2 wherein the strain gauge comprises a pair of strain gauges connected by a Wheatstone bridge.

4. The device of claim 1 further comprising a fret wire positioned across a latitudinal axis of the finger contact board.

5. The device of claim 1 wherein the stringed musical instrument is one selected from a group consisting of guitar, violin, cello, bass, bass guitar, and viola.

6. The device of claim 1 further comprising a non-transitory computer readable medium programmed for measuring and analyzing forces detected by the force transducers.

7. A device for measuring force used in playing a musical instrument comprising:
an actuating element, wherein the actuating element must be engaged either directly or indirectly by a musician in order to create a sound with the musical instrument; and
a force transducer coupled to the actuating element, such that a force applied to the actuating element is detected by the force transducer.

8. The device of claim 7 further comprising a non-transitory computer readable medium programmed for measuring and analyzing forces detected by the force transducers.

9. The device of claim 8 further comprising a display to show the musician the forces detected by the force transducers.

10. The device of claim 7 wherein the musical instrument is one selected from a group consisting of guitar, violin, cello, bass, bass guitar, and viola.

11. The device of claim 10 wherein the actuating element comprises one selected from a group consisting of at least one of a nut, a bridge, a fret, a fretboard, and a fingerboard.

12. The device of claim 10 wherein the actuating element includes a fret wire.

13. The device of claim 12 wherein the fret wire extends across a latitudinal axis of the actuating element.

14. The device of claim 7 comprising a display for the musician to show the forces applied.

15. The device of claim 7 further comprising a source of feedback to the musician when the force applied is outside of a predetermined range.

16. A method of measuring force used in playing a musical instrument comprising:
detecting force applied to an actuating element of the musical instrument, wherein the actuating element is engaged either directly or indirectly by a musician in order to create a sound with the musical instrument;
measuring the force applied to the actuating element;
analyzing the forces applied to the actuating element; and
displaying the forces applied to the actuating element.

17. The method of claim 16 further comprising providing feedback to the musician if the force applied is outside of a predetermined range.

18. The method of claim 17 wherein the feedback takes the form of haptic feedback.

19. The method of claim 16 further comprising detecting the force applied to a string of a stringed instrument.

20. The method of claim 19, further comprising detecting the force applied to a fret wire of a guitar.
